(19) United States
(12) Patent Application Publication
(10) Pub. No.: US 2024/0286680 A1
(43) Pub. Date: Aug. 29, 2024

(54) VIBRATION DAMPER

(71) Applicant: SUMITOMO RIKO COMPANY LIMITED, Aichi (JP)

(72) Inventors: Dennis LEIP, Gelnhausen (DE); Sebastian BOES, Brachttal (DE)

(21) Appl. No.: 18/441,499

(22) Filed: Feb. 14, 2024

(30) Foreign Application Priority Data
Feb. 23, 2023 (DE) 10 2023 104 485.0

(51) Int. Cl. B62D 21/11

(52) U.S. Cl. CPC B62D 21/11

(57) ABSTRACT

A vibration damper is disclosed which comprises a base portion for fixing to a vibration source. At least one spring portion is provided which is held on the base portion via at least one bracket. A damper mass is provided for absorbing vibration energy from the vibration source, and which has at least one continuous opening through which the spring portion extends.

### CROSS-REFERENCE TO RELATED APPLICATIONS

This application claims the priority of German patent application DE 10 2023 104 485.0, filed Feb. 23, 2023, the entire content of which is hereby incorporated by reference.

### FIELD

The present disclosure relates to a vibration damper and/or to a damping device which is designed to be fixed to a vibration source, in particular a vehicle body, in order to damp vibrations which can be caused by the locomotion of the vibration source, for example on a road, or by activities of the vibration source itself, such as engine vibrations. Such a vibration damper comprises a base portion for fixing to the vibration source, a spring portion and a damper mass for absorbing vibration energy from the vibration source.

### BACKGROUND

A prior-art vibration damper is for example known from U.S. Pat. No. 11,193,552 B2. In this vibration damper, a damper mass which is referred to in said document as a vibration body is fixed to a base portion via respective holding geometries embodied as springs at its ends, wherein the base portion is to be fixed to the vibration source, such as the vehicle body. The springs engage the ends of the damper mass and extend in the same direction as the main direction of extension of the damper mass. This prior-art vibration damper requires various assembly steps and rather complex individual parts. The problem can also then occur that the springs which hold the damper mass snap. The damper mass can then move freely and become a danger.

### SUMMARY

An object of the embodiments of the present disclosure is to provide a vibration damper which is simple in design, can be assembled cost-effectively and can in principle be used even when the availability of space is difficult.

In accordance with an embodiment, a vibration damper comprises a base portion for fixing to a vibration source, in particular a vehicle body. At least one spring portion comprising two ends is provided, which is held on the base portion via at least one bracket. At least one damper mass and/or vibratory mass for absorbing vibration energy from the vibration source is arranged on the base portion, wherein the damper mass exhibits at least one continuous opening through which the spring portion extends, preferably transverse to the main direction of extension of the damper mass.

The damper mass can also be embodied with a cavity at one end region of the damper mass or preferably at two or both end regions of the damper mass. These cavities can likewise be continuous, like the continuous openings, or can also be embodied only in that they enable a spring portion to be assembled.

In this way, the spring portion can be held at both ends via the bracket, wherein the spring portion passes through the continuous opening and/or cavity in the damper mass, such that the damper mass can oscillate freely, damped by the spring portion, in order to absorb vibration energy and therefore mitigate disruptive vibrations.

The spring portion preferably exhibits a cylindrical or in particular oval to elliptical shape, the end regions of which exhibit respective receiving contours which the bracket engages, wherein the spring portion is preferably manufactured from a permanently elastic material.

The end regions of the spring portion exhibit the receiving contours and/or engagement geometries which the holding geometries of the bracket engage, wherein the connection can be established by press-fitting, wherein the spring portion can be pressed into the continuous opening in the damper mass.

The holding geometries of the bracket, which is provided on the base portion, preferably exhibit a pincer-like embodiment, such that the end regions of the spring portion can be pressed into the preferably pincer-like holding geometries.

The base portion can have two or more brackets for holding respective spring portions. The number of brackets and the number of spring portions can be adjusted to the number of continuous openings in the damper mass. It is also possible to provide multiple damper masses which comprise separate spring portions, wherein the spring portions and the damper masses can be embodied such that they damp different vibration ranges, i.e. it is for example possible to provide two or three damper masses of different masses on a base portion, fixed to the base portion by means of adapted spring portions, in order to be optimized for different vibrations in different frequency ranges, to achieve improved damping.

The base portion can have at least one fastening geometry which penetrates the damper mass without contacting it and which is preferably at least partially provided with a permanently elastic surface layer. This enables a hard contact, which could cause an unpleasant knocking noise, to be avoided due to the permanently elastic surface layer when the damper mass is deflected to an extreme extent which could lead to contact with the fastening geometry or the base portion.

The design of the base portion in conjunction with the damper mass, and the way in which it is screwed to the vehicle, results in a captive connection, i.e. even if the elastomer fails (i.e. the spring snaps in two), the damper mass is trapped and cannot fall away, i.e. despite one or more (or all) spring portions snapping, the base portion will hold the damper mass fixed to the vibration source and/or vehicle via the fastening geometry, and the damper mass cannot become a source of danger.

The spring portion is preferably pressed into the opening in the damper mass, for which purpose a constriction region can advantageously be provided, for example centrally on the outer circumference of the cylindrical spring portion. Following the pressing-in process, the damper mass is securely fixed on the spring portion, and the connection between the spring portion and the damper mass cannot be impaired even by significant impacts and/or vibrations which can occur when a vehicle drives over a road with potholes.

The spring portion is advantageously equipped with a hollow space, preferably at each of its two ends, which facilitates deforming, i.e., reversibly deforming, the spring portion during the press-fitting process. The hollow space can be cylindrical and can extend approximately up until just short of the constriction in the spring portion. The spring portion can be equipped with reinforcement regions at its ends, which can provide the advantage that the holding geometries of the bracket enable the spring portion and therefore the damper mass to be fixed in a reinforced way.

The present disclosure explains in more detail below alternate embodiments and refers to the attached figures, wherein identical reference signs are used uniformly for functionally identical parts across all of the embodiments, such that repeated descriptions of identical constituent parts of the vibration damper in accordance with the embodiments can be omitted. The drawings show:

### BRIEF DESCRIPTION OF THE DRAWINGS

FIG. 1 is a perspective view of an embodiment of a vibration damper;

FIG. 2 is a perspective view of a spring portion;

FIG. 3 is a perspective view of another embodiment;

FIG. 4 is a cross sectional view taken along a longitudinal axis through the embodiment shown in FIG. 3, which is being held on a vibration source;

FIG. 5 is perspective view of a base portion of the embodiment shown in FIGS. 3 and 4;

FIG. 6 is a perspective view of the damper mass of the embodiment shown in FIGS. 3 and 4;

FIG. 7 is a cut away perspective view, partially in cross section of an assembly arrangement of the embodiment shown in FIGS. 3 and 4;

FIG. 8 is a cut away perspective view partially in cross section of a spring portion in its assembly position with respect to the damper mass and with respect to the bracket on the base portion; and

FIG. 9 is a perspective plan view of an alternate embodiment.

### DETAILED DESCRIPTION

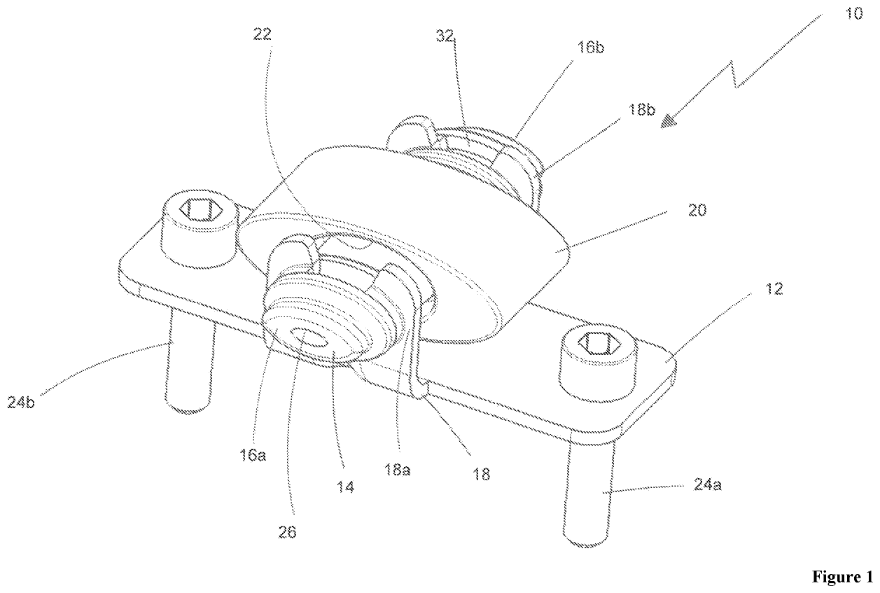

FIG. 1 shows an embodiment in which a vibration damper 10 is shown in a perspective view. The vibration damper 10 comprises a base portion 12 which can be fixed to a vibration source, such as a vehicle body, via fastening devices 24a, 24b, such as stud bolts. Where reference is made to a vibration source and/or vehicle body, this can also mean a part of the vehicle body, such as a hatchback, a door, a vehicle roof lining or the like.

A bracket 18 which is provided on the base portion 12 exhibits two holding geometries 18a, 18b via which a spring portion 14 is held at both ends 16a, 16b. The two end regions 16a, 16b of the spring portion 14 exhibit respective engagement geometries 32 which are preferably cylindrically symmetrical and which the holding geometries 18a, 18b of the bracket 18 can engage. The holding geometries 18a, 18b preferably exhibit a pincer-like embodiment, wherein mutually opposing limbs provided on the holding geometries 18a, 18b engage the engagement geometries 32 of the spring portion 14 in a pincer-like way. When the spring portion 14 is assembled on the holding geometries 18a, 18b, the end regions 16a, 16b of the spring portion 14 are correspondingly pressed into the pincer-like limbs, wherein the preferably cylindrical hollow spaces 26 at the two end regions 16a, 16b of the spring portion 14 support a reversible deformation of the end regions 16a, 16b.

It should be noted that the spring portion 14 extends substantially perpendicular to the main direction of extension of the damper mass 20. The spring properties of the spring portion 14 are utilized perpendicular to the main direction of extension of the spring portion 14. The spring portion 14 is preferably employed as a sort of plate spring.

Since the spring portion 14 is manufactured from a flexible material, such as rubber, latex, a rather soft plastic material or the like, such as by injection molding or the like, the spring portion 14 will return to its original shape again following deformation, so as to achieve a fixed mechanical connection between the spring portion 14 and the bracket 18.

Configuring the spring portion 14 to be rotationally asymmetrical can cause it to have different damping properties in different spatial directions. It is then also possible to set combinations of damper properties in the three spatial directions X, Y, Z and/or mode ratios. One damper mode can for example vary with respect to one or more other damper modes (for example, a first mode is 20 Hz in the X direction, and a second mode is 30 Hz in the Z direction). By altering the design of the spring portion 14, it is possible to configure the vibration system such that the vibrating paths are equal in the plus and minus directions. For this purpose, the weight of the damper mass in conjunction with the rigidity of the spring portion 14 must be correspondingly attuned in the latter.

Before the spring portion 14 is fixed to the bracket 18, a damper mass 20 is connected to the spring portion 14, wherein the damper mass 20 exhibits a continuous opening 22 into which the spring portion 14 is pressed. Once the vibration damper 10 shown is assembled, the damper mass 20 is assembled on the spring portion 14 at a distance from the base portion 12 and can oscillate freely, in order for example to damp vibrations, wherein the holding geometries 18a, 18b hold the end regions 16a, 16b of the spring portion 14 at a sufficient distance from the base portion 12.

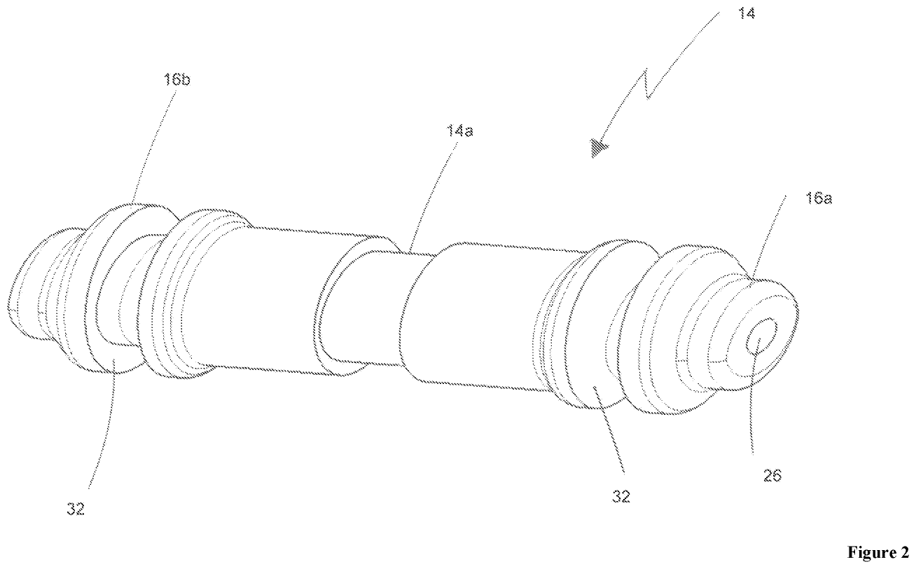

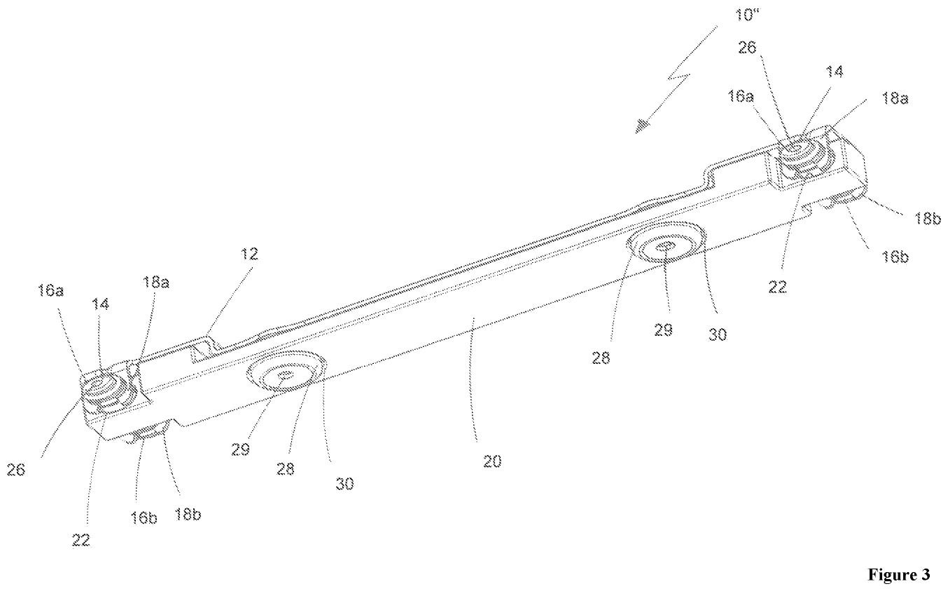

FIG. 2 shows a perspective view of the advantageously cylindrical spring portion 14, such as can be used in the embodiment in accordance with FIG. 1 but also in the other embodiment. The ends of the spring portion 14 exhibit engagement geometries 32 which are designed to serve as receiving contours for the holding geometries 18a, 18b in accordance with FIG. 1. Corresponding engagement geometries 32 are provided at both end regions 16a, 16b of the spring portion 14. A hollow space 26 which is likewise provided at both end regions 16a, 16b of the spring portion 14 facilitates press-fitting the spring portion 14 while assembling both the damper mass 20 on the spring portion 14 and the end regions 16a, 16b of the spring portion 14 on the holding geometries 18a, 18b of the embodiment in accordance with FIG. 1 and the other embodiments in accordance with the subsequent FIG. 3 and onwards. A constriction region 14a in the middle of the cylindrically symmetrical spring portion 14 serves to fix the damper mass 20 on the spring portion 14 in a predetermined position. The hollow spaces 26 at the two end regions 16a, 16b of the spring portion 14 are also expedient when press-fitting the spring portion 14 as required for this purpose. Once all the press-fitting processes are complete, the reversibly deformed regions of the spring portion 14 assume their original shape again, so as to enable a fixed though not inextricable mechanical connection between the individual constituent parts of the vibration damper 10.

Another embodiment of a vibration damper 10′ is shown in a perspective view in FIG. 3, wherein the constituent parts which have been described with respect to the first embodiment according to FIG. 1 correspond in principle to the constituent parts shown in this case.

Only two spring portions 14 are provided in the vibration damper 10′, and an elongated damper mass 20 extends between these spring portions 14, wherein the base portion 12 likewise extends longitudinally in the same way. Respective spring portions 14 which are provided in the two continuous openings 22 provided at the respective ends of the damper mass 20 can be similar or identical, as shown in FIG. 2.

The damper mass 20 exhibits two assembly cavities 30 through which assembly cups 28 which are constituent parts of the base portion 12 extend.

The assembly cups 28 exhibit assembly openings 29 through which fastening devices 24a, 24b in accordance with FIG. 1 can be inserted in order to connect the overall arrangement of the vibration damper 10′ to a vibration source. A distance between the assembly cavity 30 of the damper mass 20 and the assembly cup 28 is of course provided, in order not to impair the free oscillation of the damper mass 20.

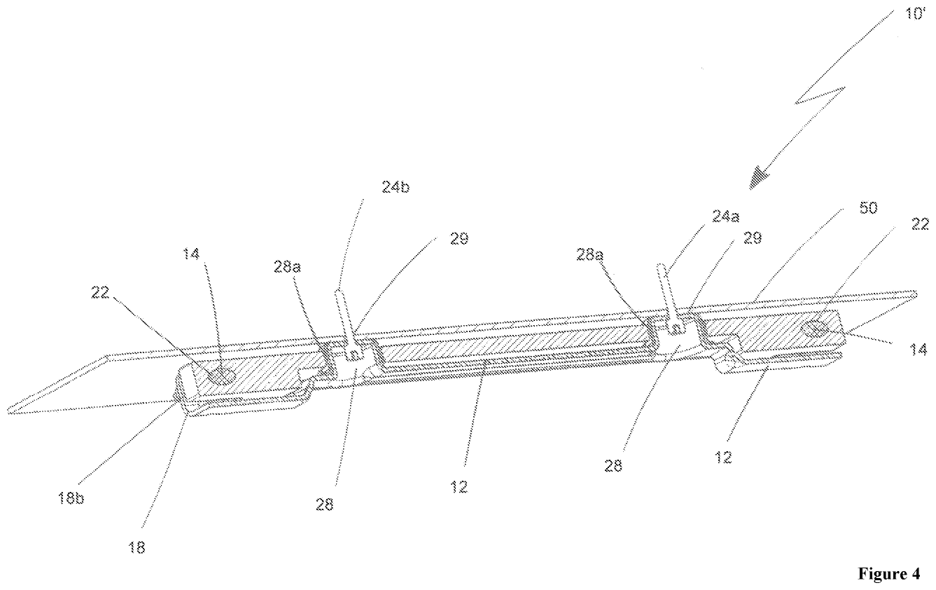

FIG. 4 shows a situation in which the vibration damper 10′ is assembled in relation to a vibration source 50, such as a vehicle body. In this case, fastening devices 24a, 24b are schematically shown via the assembly cups 28, such that the fastening devices 24a, 24b hold the damping device 10′ on the vibration source 50. The sectional view shows how the spring portion 14 is orientated in the continuous opening 22 in the damper mass 20 with no distance. As is shown, the spring portion 14 need not necessarily be round in cross-section, but rather can also be oval in shape. The seating of the spring portion 14 within the continuous opening 22 of the cavity 23 is located at the constriction region 14a of the spring portion 14 in accordance with FIG. 2.

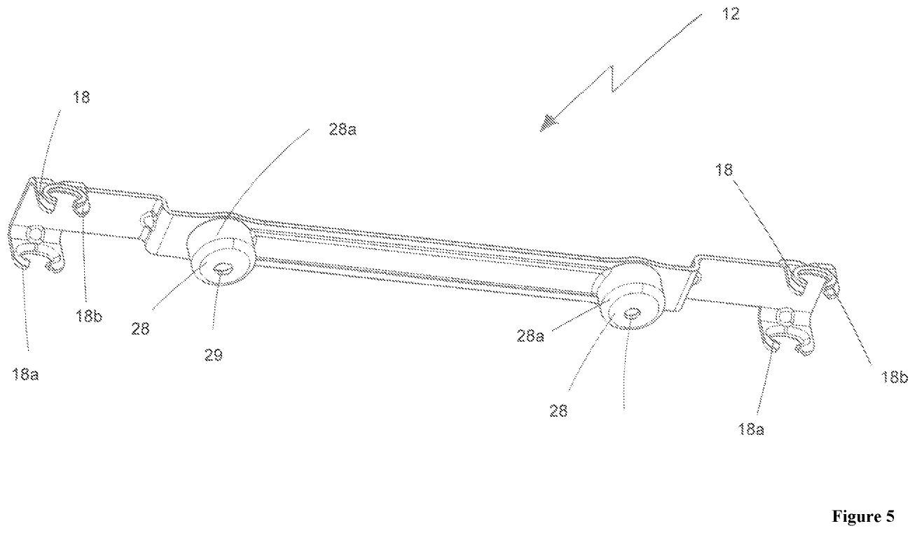

FIG. 5 shows the base portion 12 of the vibration damper 10′ in accordance with said other embodiment. In this case, the pincer-like embodiment of the bracket 18 comprising the two holding geometries 18a, 18b is shown separately. A permanently elastic surface layer 28a can be formed on the assembly cups 28, wherein in the event of violent impacts, such as when a vehicle drives through a pothole, the permanently elastic surface layer 28a can prevent a hard contact between the damper mass 20 and the base portion 12, of which the assembly cup 28 is a part.

The bracket 18 can of course also be embodied differently, for example as an angled metal sheet comprising an eye through which an end region 16a and/or 16b is pressed. A corresponding angled sheet-metal limb comprising an opening and/or eye (not shown) is then assigned to each end region 16a, 16b of the spring portion 14.

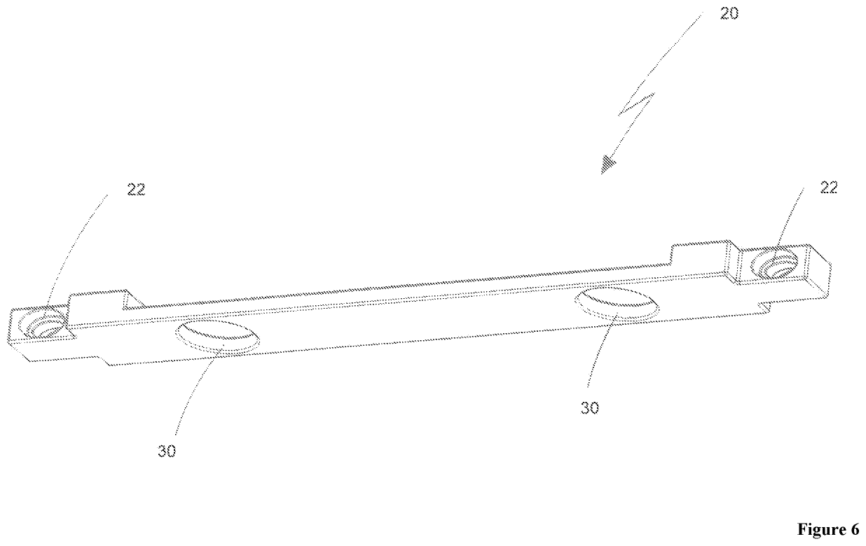

FIG. 6 shows a perspective view of a damper mass 20 and in particular the continuous openings 22 at the two ends of the elongated damper mass 20. The continuous openings 22 exhibit contours which enable the spring portion 14 to be better held, in particular via its constriction region 14a, on the damper mass 20. In this case, FIG. 6 also again shows the assembly cavities 30 separately.

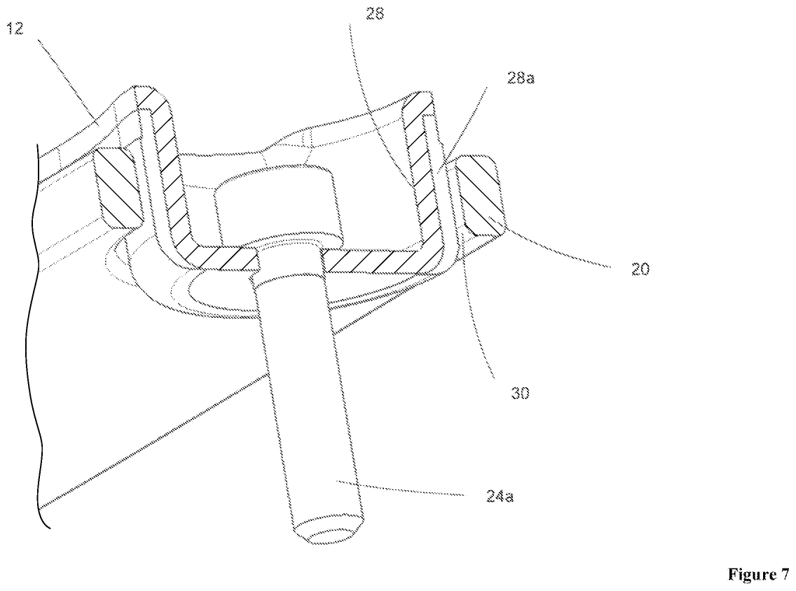

FIG. 7 is a partial sectional view which shows that there is a gap, which enables free vibrations of the damper mass 20, between the inner surface of the assembly cavity 30 and the outer surface of the assembly cup 28, which in this case is provided by a permanently elastic surface layer 28a.

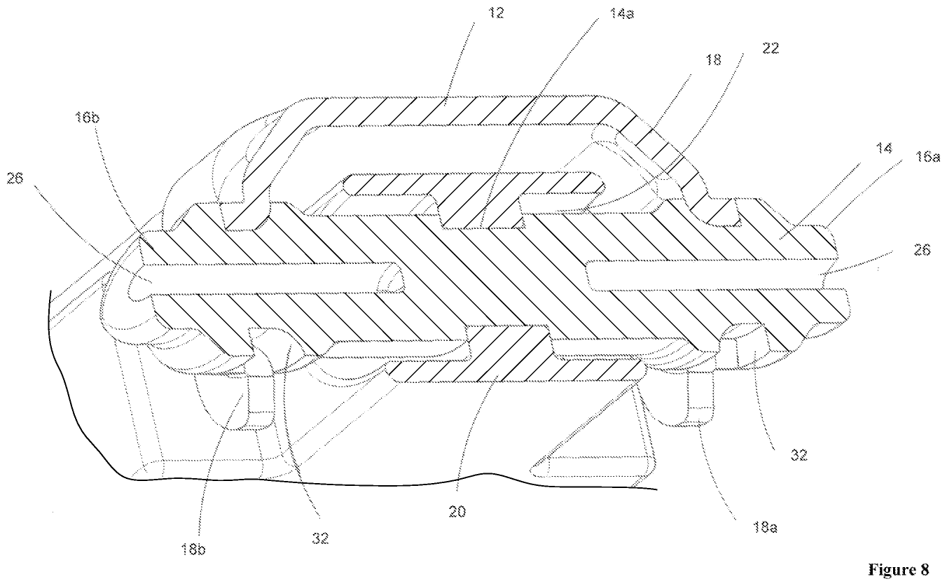

FIG. 8 shows again in detail the position of the spring portion 14 relative to the damper mass 20 and relative to the base portion 12 and the latter's brackets 18 and/or holding geometries 18a, 18b.

The damper mass 20 exhibits a surface such that a fixed contact can be provided between the constriction region 14a of the spring portion 14 and the damper mass 20. The continuous opening 22 is provided with a bulge in the region of the constriction region 14a of the spring portion 14, such that a good mechanical connection between the spring portion 14 and the damper mass 20 in the longitudinal direction of the spring portion 14, i.e., its main direction of extension, can be achieved.

The spring portion 14 can be manufactured from a permanently elastic material, while the base portion 12 could for example be punched from a sheet of steel. The damper mass 20 is preferably manufactured from a heavy material in order to be able to provide a high weight for absorbing vibration energy in the smallest possible space.

The shape and weight of the damper mass 20 can be altered to any configuration, wherein a system which operates very advantageously is provided by adapting the spring portion 14 (adapting its rigidity, shape, Shore hardness, etc.). The spring portion 14 can thus be used as a modular solution, i.e., multiple different spring portions 14, base portions 12, etc. can be provided and combined as required.

The configured frequency and vibration modes can be set within the frequencies which are typical in such cases, i.e., approximately 10 Hz or 15 to 200 Hz or 200 Hz. High-frequency natural frequencies of up to 1500 Hz can also be at least partially damped in special cases.

Advantages in terms of process time are provided by the fact that the spring portion 14 is a separate component part which, once vulcanized, is integrated into the damper mass 20 around the base portion 12. There is also no need to heat relatively heavy damper masses in the vulcanizing tool, such that the vulcanizing time can be significantly reduced. This also saves on energy (heating the mass).

The constriction region 14a on the spring portion 14, which serves to integrate the spring portion 14 into the damper mass 20 using an integrating tool, can ensure a positionally correct position, such that an incorrect installation for the purpose of attuning can be ruled out.

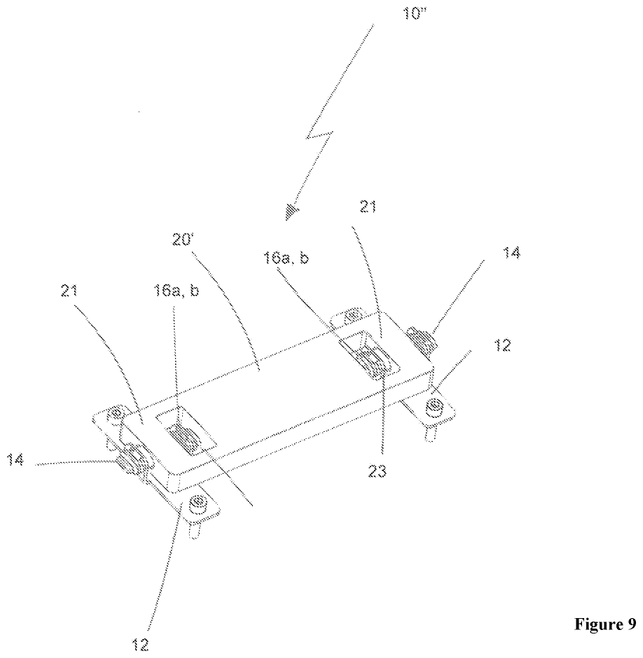

FIG. 9 illustrates an additional embodiment of a vibration damper 10″ In this case, the damper mass 20′ is held by the respective base portions 12, such as are used in accordance with FIG. 1, via spring portions 14 (see FIG. 2). The damper mass 20′ is provided with cavities 23 at both end regions 21 of the damper mass 20′. The cavities 23 are preferably continuous, i.e., correspond to the continuous openings 22 in accordance with the above embodiments. The cavities 23 can however also be embodied to be non-continuous, such that it is possible to press-in the spring portion 14 and its bracket, as shown for example in FIG. 1. In this case, a clear view onto the end region 16a, 16b of the spring portion 14 accommodated in the cavity 23 would be denied. It is of course also possible to correspondingly use the design comprising the assembly cup 28 and the assembly cavity 30 of the other embodiment in accordance with FIGS. 3 to 8 in this embodiment, in particular in order to also achieve a captive connection in this case.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

10, 10′, 10″ vibration damper
12 base portion
14 spring portion
14a constriction region
16a, 16b end regions
18 bracket
18a, 18b holding geometry
20, 20′ damper mass
21 end region
22 continuous opening
23 cavity
24a, 24b fastening device
26 hollow space
28 assembly cup
28a permanently elastic surface layer
29 assembly opening
30 assembly cavity
32 engagement geometries, receiving contours
50 vibration source, vehicle body

1. A vibration damper comprising:
a base portion for fixing to a vibration source;
at least one spring portion comprising two end regions, which is fixed to the base portion via at least one bracket; and
at least one damper mass for absorbing vibration energy from the vibration source,
wherein the damper mass has at least one preferably continuous opening or cavity, through or into which the spring portion extends.

2. The vibration damper according to claim 1, wherein the spring portion exhibits a cylindrical or in particular oval to elliptical shape, the end regions of which exhibit respective engagement geometries which the bracket engages via holding geometries, wherein the spring portion is manufactured from a permanently elastic material.

3. The vibration damper according to claim 1, wherein the bracket exhibits holding geometries which are assigned to the respective end regions of the spring portion and which can be moved into engagement with the engagement geometries at the end regions of the spring portion.

4. The vibration damper according to claim 3, wherein the holding geometries result in a pincer-like embodiment.

5. The vibration damper according to claim 1, wherein the base portion comprises two or more brackets for holding respective spring portions.

6. The vibration damper according to claim 1, wherein multiple spring portions are provided which are held via respective brackets and which hold a damper mass.

7. The vibration damper according to claim 1, wherein the base portion has at least one fastening geometry which penetrates the damper mass without contacting it and which is at least partially provided with a permanently elastic layer.

8. The vibration damper according to claim 1, wherein the spring portion is pressed into the continuous opening in the damper mass.

9. The vibration damper according to claim 1, wherein the spring portion is pressed into the holding geometries on the base portion.

10. The vibration damper according to claim 1, wherein the spring portion is equipped with a hollow space at its two end regions.

11. The vibration damper according to claim 1 wherein the spring portion is embodied with reinforcement regions at its end regions.

12. The vibration damper according to claim 1, wherein end regions of the damper mass are embodied with a cavity into which respective spring portions extend.

13. The vibration damper according to claim 12, wherein respective holding geometries extend into the cavities in order to hold a respective end region of a spring portion.

14. The vibration damper according to claim 13 wherein the cavities are continuous.

15. The vibration damper according to claim 1 wherein the vibration source is a vehicle body.
